(19) United States
(12) Patent Application Publication
(10) Pub. No.: US 2003/0200488 A1
(43) Pub. Date: Oct. 23, 2003

(54) Method and network for containing the spread of damage from a network element subject to compromise

(76) Inventor: Paul C. Lloyd, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/125,625

(22) Filed: Apr. 17, 2002

(51) Int. Cl. G06F 11/30

(52) U.S. Cl. 714/43

(57) ABSTRACT

A method and computer network for containing the spread of damage from a compromised element. A sensor is arranged to detect suspicious behavior of other identifiable network elements. When such suspicious behavior is detected, the identity of such network element is addressed and input to a directory. Such directory is addressable by various network elements, including network servers and routers or gateways that define choke points of the network, over either a network infrastructure (wide area network) or network interconnections (local area network). Such network architecture permits the various choke point network elements (controllers) to refer to the status of network elements requesting services, such as network configuration, that could result in the spread of damage, when deciding to provide or deny such services.

### BACKGROUND

1. Field of the Invention

The present invention relates to computer networks. More particularly, this invention pertains to a network and a method for containing the spread of damage within the network from elements subject to compromise.

2. Description of the Prior Art

The networking together of computers has greatly increased the resources available to the users of pc's and other digital devices. Unfortunately, the accessing of resources over a network subjects the devices, including clients, personal productivity and entertainment devices, to attack by maladies introduced over the same network. Such maladies can include viruses, worms and malicious code introduced through email, file or other content. In general, any programmable device on a network that is capable of running code is subject to compromise as its operation is corruptible by the insertion of malicious code.

The network itself can serve as a vehicle for propagating damage from the corrupted or infected element throughout the network. The substantial number of clients and other elements that communicate over a single network makes it essential that such propagation be minimized. While damage can often be rapidly and easily detected by other elements on a network (e.g., by observing the damaged element's attempts to infect other elements), vast numbers of elements, such as personal productivity devices and personal entertainment devices, are used by individuals who lack the training or motivation to detect their own damaged state.

Existing solutions to the problem of limiting the propagation of damage from compromised elements throughout a computer network have required operation on the infected element (e.g. antivirus software). This requires, of course, installation of the appropriate measures as well as their updating and is thus subject to user and/or network attention. Such solutions do not allow network administrators to notify client users of the damaged state of an element and thereby prevent the user from encountering problems with the already-recognized infected element. While such solutions prevent further spread of contamination by isolating damaged elements from the rest of the network, they are unable to recognize when the element has become decontaminated and therefore ready to again function within the network. Further, they are unsupported by network operating systems (NOSs) once a damaged state is detected. Also, there is presently a lack of automated solutions for containment.

### SUMMARY OF THE INVENTION

The preceding and other shortcomings of the prior art are addressed by the present invention that provides, in a first aspect, a computer network that includes at least one identifiable network element that is subject to compromise. Such network includes at least one controller for servicing or denying a service request of at least one network element. At least one sensor is provided for detecting and identifying at least one possibly compromised network element. At least one directory is provided for storing identifications of possibly compromised network elements.

The network is arranged so that the (at least one) directory is addressable by the (at least one) sensor and accessible to the (at least one) controller. As a result, such at least one controller can deny a requested service to a requesting network element that is possibly compromised.

In a second aspect, the invention provides a wide area computer network. Such wide area network includes a plurality of local area networks that are mutually addressable over a network infrastructure. Each of the local area networks includes a plurality of identifiable network elements, at least one of which is subject to compromise.

At least one local area network includes a controller for servicing or denying a service request of at least one network element. At least one sensor is provided for detecting and identifying at least one possibly compromised network element. At least one directory is provided for storing identifications of possibly compromised network elements.

The wide area network is arranged so that the (at least one) directory is addressable by the (at least one) sensor and accessible to the (at least one) controller. In this way, the (at least one) controller can deny a requested service to a requesting network element that is possibly compromised.

In a third aspect, the invention provides a local area computer network that includes at least one identifiable network element subject to compromise. A plurality of identifiable network elements are mutually addressable over local area network interconnections.

The local area network includes at least one controller for servicing or denying a service request of at least one network element. At least one sensor is provided for detecting and identifying at least one possibly compromised network element. At least one directory is provided for storing identifications of possibly compromised network elements.

The local area network is arranged so that the (at least one) directory is addressable by the (at least one) sensor and accessible to the (at least one) controller. Accordingly, the (at least one) controller can deny a requested service to a requesting network element that is possibly compromised.

In accordance with a fourth aspect. The invention provides a method for containing the spread of damage within a computer network of the type that includes at least one uniquely identifiable network element subject to compromise. Such method is begun by sensing a possibly compromised network element. The identification of the possibly compromised network element is then stored in a directory that is accessible to network elements that comprise choke points of the network. Such directory is referred to for network identifications when a service is requested of a network element that comprises a choke point of the network. The requested service is denied when the identification of the requesting network element is present in the directory.

The preceding and other features of this invention will become further apparent from the detailed description that follows. Such description is accompanied by a set of drawing figures. Numerals and other symbols of the drawing figures, corresponding to those of the written description, point to the features of the invention with like numerals and symbols indicating like features throughout both the written description and the drawing figures.

### BRIEF DESCRIPTION OF THE DRAWINGS

FIG. 1 is a diagram of the architecture of a computer network in accordance with an embodiment of the invention in which the functions and elements of a wide area network are distributed among a plurality of local area networks;

FIG. 2 is a diagram of the architecture of a computer network in accordance with an alternative embodiment of the invention with functions and elements incorporated into a single local area network.

FIG. 3 is a flow chart that illustrates the operation of a server type of controller in accordance with an implementation of the invention;

FIG. 4 is a flow chart that illustrates the operation of a router or gateway type of controller in accordance with an implementation of the invention;

FIG. 5 is a flow chart that illustrates the operation of a sensor in accordance with an implementation of the invention;

FIG. 6 is a flow chart that illustrates the interaction, from the perspective of a network element with a network arranged in accordance with an embodiment of the invention; and

FIG. 7 is a flow chart that illustrates an implementation of the operation of a notification server in accordance with an embodiment of the invention.

### DETAILED DESCRIPTION OF THE PREFERRED EMBODIMENT

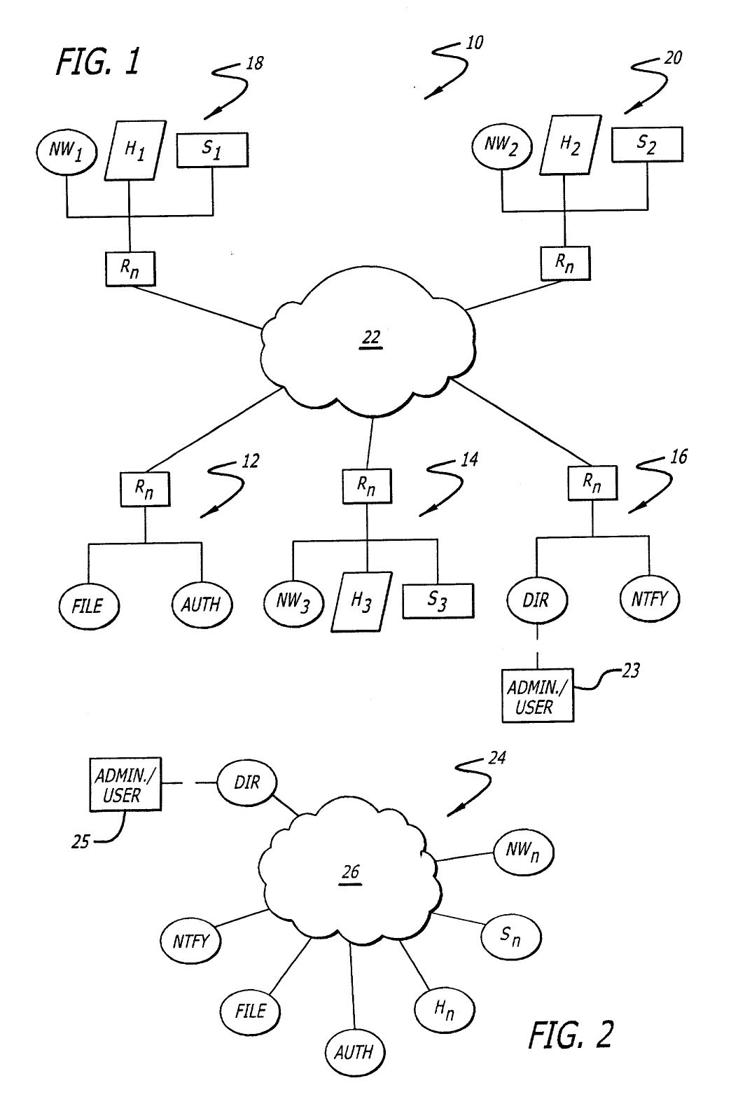

FIG. 1 is a diagram of the architecture of a wide area computer network (WAN) 10 with functions and elements distributed therein in accordance with an embodiment of the invention. The WAN 10 as illustrated in FIG. 1 includes a number of local area networks (LANs) 12, 14, 16, 18 and 20 (although it may comprise more or fewer LANs) that include elements capable of communicating over a network infrastructure 22 when properly configured. The network infrastructure 22 may comprise, for example, the INTERNET. Each LAN includes a number of programmable hardware elements, including clients and servers, that are capable of, and wired for (through servers, printer cables, etc.), interaction with one or more other LAN elements. Network-wide use of programmable hardware elements may be achieved through either physically importing an element from its originating LAN to a remote LAN (e.g. taking one's laptop computer client from one office building to another office building) or by accessing an element of a remote LAN over the network infrastructure 22.

In the diagram of FIG. 1, various functions, accomplished by means of hardware elements described and defined below, are associated with the various LANs 12 through 20. While such functions are shown to be distributed among the five LAN's 12 through 20 in FIG. 1, this is in no way intended to limit the invention to such an architecture nor to imply that any one of the illustrated LANs is limited to or incapable of performing a plurality of the distributed functions. This will become further apparent from FIG. 2, which illustrates a network architecture in accordance with another embodiment of the invention in which all functions associated with the hardware of the WAN of FIG. 1 (other than the router function) can be found within a single LAN 24 arranged in accordance with an embodiment of the invention with mutually accessible interconnections being made in the LAN 24 through local area network interconnections 26 rather through the network infrastructure 22 of the WAN 10 of FIG. 1.

Each of the network architecture diagrams of FIGS. 1 and 2 includes notations, referring to hardware elements by the symbols Hₙ, NWₙ, Rₙ, Sₙ, DIR, AUTH, FILE and NTFY. Such terms are defined below:

1. Hₙ (“network element”)=Any identifiable hardware element within the subject network that is subject to compromise by a virus or other malicious code. An identification is assumed to be associated with each element. This provides a means for other network elements (Sₙ) to observe and report the identity of a suspicious element, make inquiries into the status of an element seeking a responsive action (e.g. a request for a network configuration) and advise a user or a network administrator of the suspicious status of an element. Identifications of elements may comprise, for example, one or more of the following types of data: physical network address (such as a MAC); network address (e.g. IP address); vendor serial number of the element or a component thereof; and operating specific licensing or identifying information. Since Hₙ refers to any hardware element of the relevant network that is subject to compromise, it may also encompass, other hardware elements defined more specifically below.

2. NWₙ (“network server” (a “controller”))=A configuration server. This is a type of network hardware element that is located within the relevant network and programmed to be capable of providing a network configuration to a requesting network hardware element. A network configuration may comprise a dynamic network address assignment as well as the addresses of providers of desired services such as authentication, file sharing, etc. The ability to provide or deny a requested network configuration will be seen to render a configuration server a potential choke point for limiting the spread of damage from a damaged hardware element in a computer network in accordance with an embodiment of the invention. For this reason, a configuration server is classified within the category of a controller in accordance with the invention.

3. Rₙ (“router” or “gateway” (a “controller”))=A router, also referred to as a gateway, for directing the flow of information between a LAN and the network infrastructure. A router is capable of providing network related configuration information to network hardware elements requesting access to the network infrastructure and, as such, a router provides a potential choke point for limiting the spread of damage from a compromised hardware element in a computer network arranged in accordance with an embodiment of the invention. For this reason, a router Rₙ is classified within the category of a controller in accordance with the invention.

4. Sₙ (“sensor”)=A sensor comprising one or more properly programmed and arranged network hardware elements. Hardware elements for performing the sensor function are capable of monitoring network traffic, detecting and identify other network elements that appear to have been damaged and/or appear to be attempting to damage other network hardware elements. A sensor Sₙ may comprise either one or more servers, one or more clients, or a combination of one or more servers and clients arranged and programmed to perform the functions described above. Additionally, the function may be performed by hardware programmed to perform other functions in addition to the function of a sensor. Insofar as it is performing as a sensor Sₙ such hardware does not constitute a choke point for limiting the spread of damage within a computer network in accordance with an embodiment of the invention and therefore does not fall within the category of a controller. An example of a Sₙ is the platform and software arrangement provided under the trademark REAL SECURE NETWORK SENSOR by Internet Security Systems of Atlanta, Ga.

5. DIR (“directory”)=A directory that serves as a repository of identifying information on all hardware elements of the relevant computer network that have been found (via the Sₙ function) to be suspected of being damaged and/or attempting to damage other network hardware elements. In addition to storing the identities of suspicious network hardware elements, DIR is manually addressable by a network administrator/user (indicated by 23 in the wide area network architecture of FIG. 1 and by 25 in the local area network architecture of FIG. 2) to enable such an administrator/user to clear DIR of information that identifies a formerly-suspicious network hardware element once the administrator/user has taken corrective actions (upon receiving notification, see flow charts below) that render the element suitable for re-incorporation into the operation of the network. The hardware for implementing a directory DIR may comprise either one or more servers, one or more clients or a combination of clients and servers configured to permit network hardware elements of the controller category (those that serve as choke points of the relevant computer network) to address the identities of network hardware elements Hₙ determined to be exhibiting suspicious behavior indicating possible damage. Hardware arranged and programmed to function as a DIR, without more, does not constitute a choke point for limiting the spread of damage in a computer network in accordance with an embodiment of the invention and therefore does not fall within the category of a controller;

6. AUTH (“authentication server” (a “controller”)=An authentication server that is arranged and programmed to provide credentials to requesting network hardware elements to permit the human users of such hardware elements to perform desired actions requiring access to other hardware elements. Such a user, operating a client (his network hardware element Hₙ) and desiring to perform a function that requires access to files stored on a remote server will require clearance by an authorization server. Credentials provided by an authorization server can also be presented to servers as part of authenticated transactions. In accordance with an embodiment of the invention, a server or other element performing AUTH is located, arranged and programmed to provide a choke point for limiting the spread of damage from a damaged host throughout the relevant network. Therefore, an authentication server falls into the category of a controller in a computer network in accordance with an embodiment of the invention.

7. FILE (“file server”)=One or more servers, clients or a combination of servers and clients that store files for access throughout the relevant network. FILE servers, clients, or both, do not contribute to limiting the spread of damage within a network and, thus, a FILE server, for example, does not fall into the category of a controller in a computer network in accordance with an embodiment of the invention.

8. NTFY (“notification server”)=One or more servers, clients or a combination of both that transmits notification of its possibly damaged state to a network element Hₙ. NFTY arranged and programmed hardware does not, of itself, function as a choke point and thus does not fall into the category of a controller in a computer network in accordance with an embodiment of the invention.

The invention provides an arrangement and a method for limiting the spread of damage from an element of any one of the LANs of the WAN 10 to any other element of any LAN (embodiment of FIG. 1) through the network infrastructure 22 or from spreading among the hardware elements Hₙ of a LAN 26 through the local area network interconnections 26. In general, the networking together of elements, while advantageous for many purposes, also provides a means for facilitating the spread of damage from hardware element to hardware element. The containment of damage in the present invention is accomplished in large measure through the utilization of interoperability and network architecture in such a way that controllers (i.e. NWₙ configuration servers, Rₙ routers and AUTH authentication servers) access information from a DIR server(s) and/or client(s) during the performance of “regular” functions on behalf or requesting network hardware elements Hₙ. Such information is examined by the controller which then grants the requested action on behalf of Hₙ only if its inquiry into DIR fails to find that the requesting hardware element has been, and is currently, identified as suspicious on the basis of observation by a sensor Sₙ.

In the event that a hardware element Hₙ is found to have been reported to DIR, controllers are then able to deny a suspicious Hₙ the ability to spread damage within the relevant network. For example, by denying a network configuration, a configuration server or a router prevents a suspicious client, for example, from spreading damage over the network infrastructure. An authorization server, by denying authorization, can prevent a suspicious hardware element from spreading damage to a FILE server, for example. A user or network administrator, informed of the suspicious status of an identifiable network hardware element, may act to take the device off-line or replace or repair it, thereafter taking action to remove the identification of the formerly suspicious element from DIR and effecting returning it on-line,

A LAN will typically include one or more servers, each of which supports, and communicates with, a plurality of clients. Each of such hardware elements is subject to attack by viruses, worms and malicious code introduced through email, file or other content. In addition, other hardware elements such as printers, storage devices, and other peripherals, are also subject to compromise by the aberrant outputs output from a compromised host and, in turn, capable spreading a virus.

A discussion of the operation of portions of the various embodiments of the invention follows. It should be kept in mind throughout such discussion that the invention is not limited to a wide area network as illustrated in FIG. 1 nor, for that matter, to a local area network as shown in FIG. 2. Nor, for that matter is the invention limited to the distribution of functional hardware shown in either of the figures for a wide area network or a local area network.

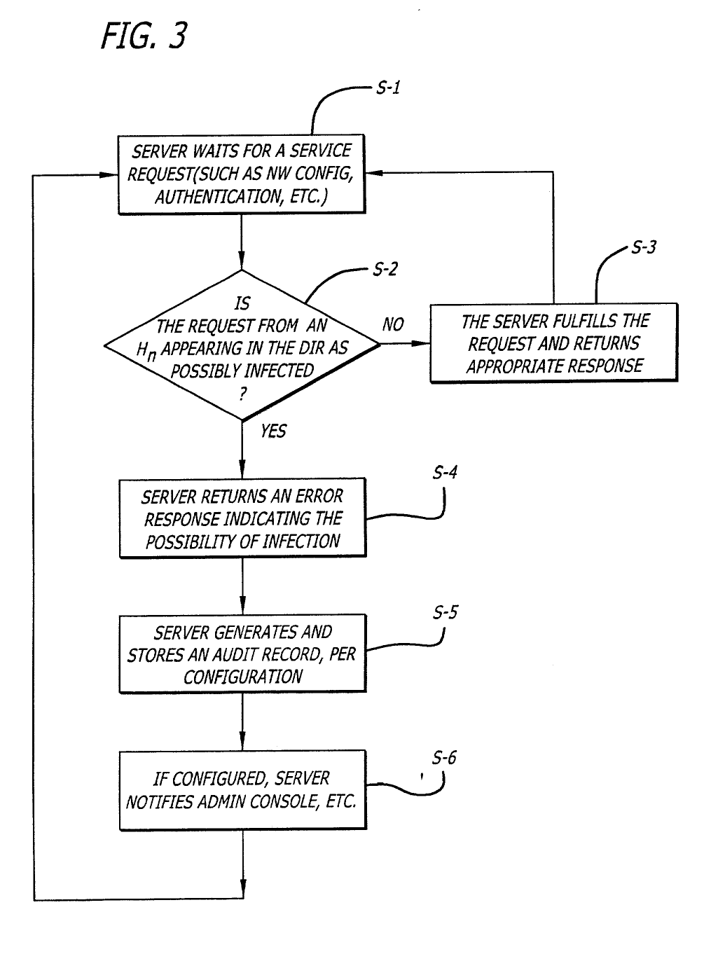

FIGS. 3 through 7 are a series of flow charts for illustrating the operation of certain of the apparatus of a network in accordance with an embodiment of the invention as described above.

FIG. 3 is a flow chart that illustrates the operation of a controller-type server (NWₙ or AUTH) in a computer network in accordance with an embodiment of the invention. Such a server provides a choke point of such a network for containing the spread of damage from a suspicious hardware element Hₙ. A controller-type server for accomplishing the operation described by the flow chart of FIG. 3 may be obtained, for example, by programming the functions described onto an appropriate hardware platform. Software available from Internet Software Consortium (ISC) of Redwood City, Calif. under the trademark DHCP 3.0 will be understood by those skilled in the art to be suitable for programming such hardware to perform all functions of a network server NWₙ. Similarly, those skilled in the art may program an appropriate hardware platform to perform as an authentication server AUTH by employing software available from the Massachusetts Institute of Technology of Cambridge, Mass. under the trademark KERBEROS V-5 Authentication Software.

The on-line controller server, after waiting, receives a service request (e.g, a network configuration or authentication to permit access to a non-controller type FILE server) at step S-1. The controller server then transverses the network infrastructure 22 (wide area network of FIG. 1) or the local area network interconnections (local area network of FIG. 2) to access DIR and search for the presence of information identifying the requesting Hₙ as a network element that has been identified as suspicious or possibly infected at step S-2. (Note: As mentioned above, DIR can be located physically at a remote LAN or within the LAN of the requesting element or may even be co-located with the element.)

In the event that information identifying the requesting Hₙ is not found in DIR at step S-2, the controller server fulfills the request (e.g. provides a network configuration) at S-3 and returns to the mode for receiving the next request of an Hₙ at S-1. In the event that the controller server found an identification of the requesting Hₙ as among possibly infected suspicious network elements at step S-2, it returns an “ERROR” response to the user of Hₙ at step S-4 and the request for a network configuration is denied. The denial of a network configuration prevents the transmission of signals generated at the Hₙ onto the network infrastructure 22 (wide area network 10 of FIG. 1) or through the local area network interconnections 26 (local area network 24 of FIG. 2). Thus, the controller server has functioned as a choke point for containing the spread of damage from the suspicious requesting hardware element H_{n.} At step S-5, the server may optionally generate and store an audit record of its activity.

In the event that the software of the controller server has been so configured, it also provides a notification to the console of the network administrator of the possibly compromised, or suspicious, status of the requesting Hₙ at step S-6.

The notified network administrator (23 or 25) may use the information about the requesting Hₙ obtained at step S-6 to take corrective action and, as discussed earlier, input such correction manually into DIR so that future requests of the particular Hₙ will not be wrongfully denied. After this, the controller-type server returns to the mode for receiving requests for service at step S-1.

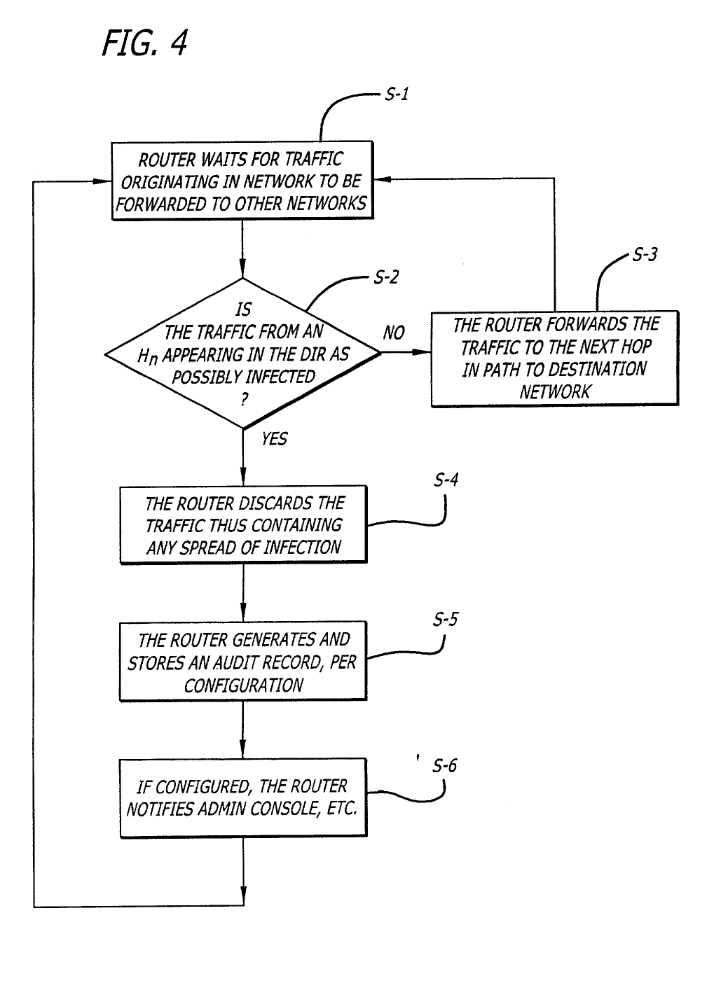

FIG. 4 is a flow chart of the operation of a router or gateway Rₙ in accordance with the invention. Comparison of this flow chart with the previous flow chart of a controller server indicates an identical sequence steps that begins at step S-1 with Rₙ waiting to receive network traffic (i.e. discrete units of data, each of which includes, in addition to a data input, both the address of the element Hₙ originating the data input and a destination address) originating in its associated LAN or transmitted through the network infrastructure 22. After interrogation of DIR at step S-2 to determine whether or not Hₙ previously been identified as possibly infected, Rₙ forwards the element to the next hop in the path to its network destination if information identifying Hₙ is not found in DIR.

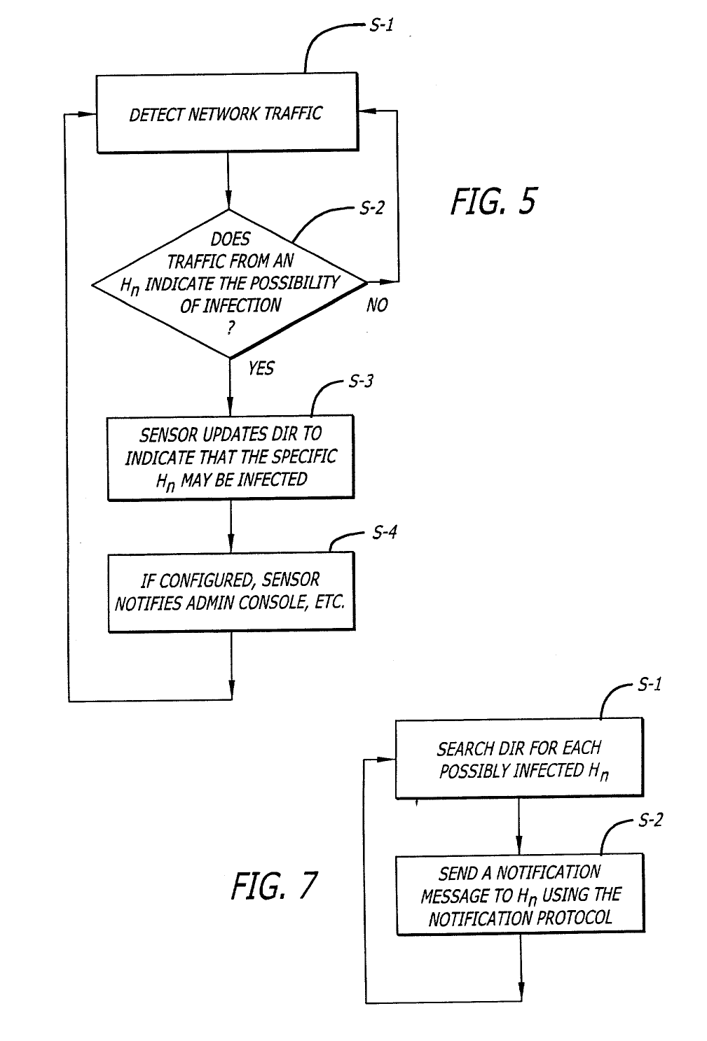

In the event that Rₙ finds an identification of the originating Hₙ in DIR, it declines to forward the data originating with H_{n,} thereby preventing the passage of any output from the suspicious Hₙ to other elements of the relevant network through either the network infrastructure 22 or the network interconnections 26. In this way, Rₙ, just as a controller server, provides and acts as a choke point to contain the damage originating with the suspicious element Hₙ and prevent it from spreading further within the relevant network. The other steps of the flow chart of FIG. 5 parallel those of the prior flow chart that describe the operation of a controller server within a network in accordance with an embodiment of the present invention. At step S-5, the router or gateway may optionally generate and store an audit record. At step S-6, Rₙ may optionally notify a network administrator 23 or administrator 25 who, as mentioned above, may take actions to address the problem and, having corrected it, update DIR by removing the address of the formerly compromised element. The operation of a router as above-described can readily be achieved, for example, by programming an appropriate hardware platform equipped with the LINUX operating system. The programming of such operations in LINUX onto an appropriate hardware program is well understood by those skilled in the art.

FIG. 5 is a flow chart that describes the operation of Sₙ within a computer network in accordance with an embodiment of the invention. The function of a sensor Sₙ, whether associated with one or more servers, clients or a combination of both, is to observe the outputs of one or more Hₙ's and to infer from such observation whether or not is should be deemed suspicious and its identifying information input to DIR. It should be kept in mind that certain Sₙ network hardware elements, just as any other Hₙ, may become compromised and unable to provide reliable outputs. It is assumed that the compromised state of such a sensor will be detected by another Sₙ and that the sensor function will be appropriately distributed throughout the network that the possible compromise of one or more Hₙ elements for performing the sensor function not invalidate this function within a computer network in accordance with an embodiment of the invention.

The Sₙ element detects the presence of network traffic (within its local area network) at step S-1. At step S-2, Sₙ examines the traffic to determine whether it includes any network elements whose outputs cause it to infer the possibility of compromise. In the event that no such element is detected, the sensor element returns to S-1 and continues examination of the network traffic. In the event that Sₙ detects a possibly compromised element within the network, it sends identifying information of the suspect element to DIR at step S-3. Should the software of Sₙ be so arranged or configured, it then notifies the network administrator (23 or 25) of the possible compromise of the requesting Hₙ at step S-4, thereby enabling the administrator to correct the problem and manually input such correction into DIR thereafter.

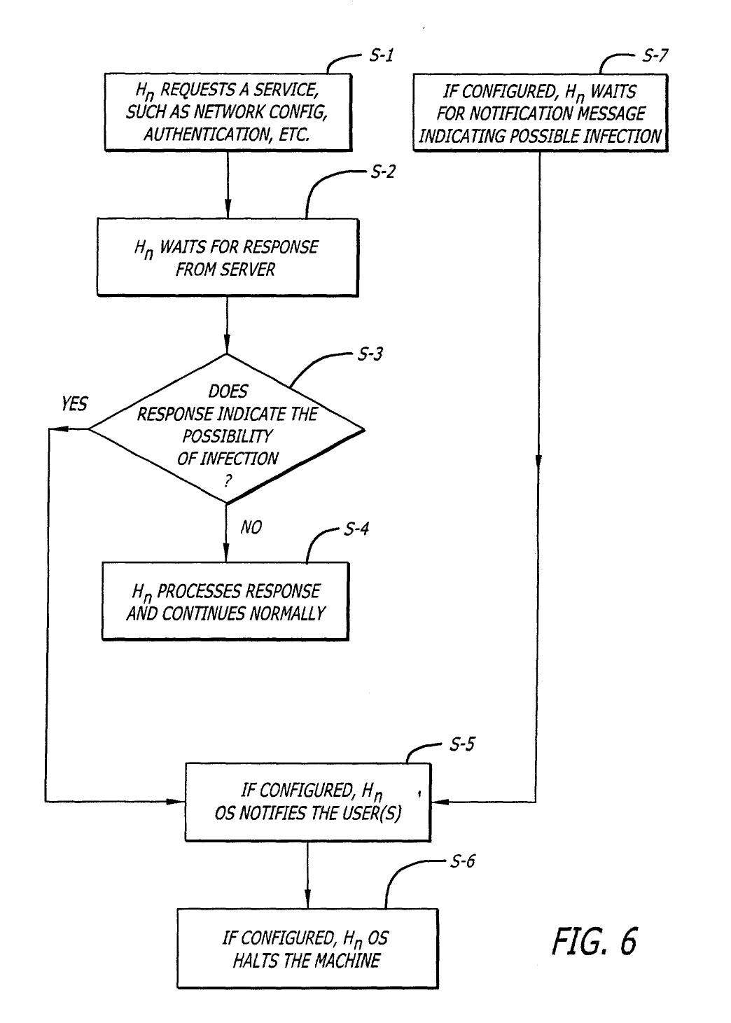

FIG. 6 is a flow chart that illustrates the interaction, from the perspective of a network hardware element Hₙ, with a choke point in a network arranged in accordance with the invention. At step S-1 the element requests a service (e.g a network configuration permitting it to access the network infrastructure 22) from a controller server. After waiting for action or another response at step S-2, it receives and examines the response at step S-3 for the possibility that such response indicates that it (i.e. Hₙ) may be infected or compromised. In the event that the controller server does not receive an indication from DIR that Hₙ was possibly infected or suspicious, the controller server performs the requested service and Hₙ then proceeds at step S-4. If, on the other hand, the response from the controller server at step S-3 indicates to Hₙ that it is possibly infected or compromised (and the controller server thereby denies the requested service), its operating system is configured to notify user(s) of Hₙ of this situation at step S-5. Should the operating system of Hₙ be so configured, it will then shut down Hₙ at step S-6. As mentioned, the notification of users and network administrators permits human intervention to repair, and then update DIR, so that Hₙ can then be returned to on-line functioning. Step S-7 indicates that an Hₙ that has previously received a network configuration is always subject to receipt of notification of detection of its possible infection by a sensor Sₙ, even in the absence of its request for service from a controller server or router. The receipt of such notice will, if its operating system is so configured, trigger the notification of users of Hₙ at step S-5 and result in the halting of operation of operation of Hₙ at step S-6, again if its operating system is so configured. Thus it is seen that, in addition to the notification of users and administrators, in the present invention the spread of damage from a damaged host can also involve the modality of automatically shutting down the compromised network element.

FIG. 7 is a flow chart that illustrates an implementation of the operation of a notification server NTFY in accordance with the invention. The flow chart comprises a continuous loop that continually recycles from step S-1 in which DIR is searched (with a frequency that is a function of system configuration parameters) for possibly infected Hₙ's, and, employing a notification protocol, transmitting notification of their possibly infected status, to such Hₙ's at step S-2. Referring to the prior flow chart, should the operating system of a notified Hₙ be properly arranged or configured, this can lead to notification by Hₙ to its users of its suspicious status, thereby possibly causing the users to take protective and/or corrective actions. Additionally, the operating system of the notified network hardware element may be configured to shut off Hₙ upon receipt of notification of its suspicious status.

The flow chart of FIG. 7 illustrates a function of a non-controller server, a NTFY, that is extremely useful despite the fact that such a server is not a choke point of a network in accordance with an embodiment of the invention. The continuous scanning of DIR by NTFY permits the uncovering of identities of Hₙ's that have not requested any service from a controller server (or intelligent router) since an Sₙ has noticed its suspicious nature and reported this to DIR. Thus, this provides a means for addressing problems within a computer network in accordance with an embodiment of the invention at a possibly more convenient time, before the compromised Hₙ has input, for example, a request for a network configuration. As such, NTFY acts to contain damage from spread from LAN to LAN within a wide area network but also to contain the spread of damage from element to element within a local area network.

Thus it is seen that the present invention automatically contains the spread of damage from a compromised network element. By recognizing the potential use of configuration and authentication servers, for example, as choke points of a computer network configured in accordance with the invention, and by providing network arrangements in which the compromise of a network element is sensed and reported to an accessible directory, the invention is arranged to contain damage by readily preventing access to network interconnections, network infrastructure, credentials and the like that otherwise would be capable of assisting the flow of damage throughout the network. By centralizing and making accessible information concerning possibly infected network elements, the invention permits a notification and containment response to be achieved despite physical relocation of the network elements.

By allowing administrators to selectively deploy sensors, the invention allows administrators to invest in sensors based upon known risk management criteria so that the danger of compromise of some sensor hardware does not disrupt the sensor function.

While this invention has been described with reference to its presently preferred embodiment, it is not limited thereto. Rather, this invention is limited only insofar as it is defined by the following set of patent claims and includes within its scope all equivalents thereof.

What is claimed is:

1. A computer network including at least one identifiable network element subject to compromise, said network comprising, in combination:
a) at least one controller for performing or denying a service request of at least one network element;
b) at least one sensor for detecting and identifying at least one possibly compromised network element;
c) at least one directory for storing identifications of possibly compromised network elements; and
d) said network being arranged so that said at least one directory is addressable by said at least one sensor and accessible to said at least one controller whereby said at least one controller can deny a requested service to a requesting network element that is possibly compromised.

2. A computer network as defined in claim 1 wherein said at least one controller is arranged to provide an indication of possible compromise to a requesting element.

3. A computer network as defined in claim 2 including a network element arranged to provide a user with an indication of possible compromise in response to receipt of such an indication from a controller.

4. A computer network as defined in claim 3 including a network element arranged to halt operation in response to receipt of an indication of possible compromise from a controller.

5. A computer network as defined in claim 1 wherein said at least one controller comprises a network server.

6. A computer network as defined in claim 1 wherein said at least one controller comprises a router.

7. A computer network as defined in claim 1 wherein said at least one controller comprises an authentication server.

8. A computer network as defined in claim 1 further characterized in that said computer network comprises a wide area network that includes a plurality of local area networks that are mutually-addressable over a network infrastructure.

9. A computer network as defined in claim 1 further characterized in that said computer network comprises a local area network that includes a plurality of network elements that are mutually-addressable over local area network interconnections.

10. A computer network as defined in claim 1 wherein said at least one controller is arranged to respond to a request for a network configuration.

11. A computer network as defined in claim 1 wherein said at least one controller is arranged to respond to request for a credential.

12. A computer network as defined in claim 1 wherein identifications of possibly compromised elements can be manually removed from said at least one directory.

13. A wide area computer network comprising, in combination:
a) a plurality of local area networks;
b) said local area networks being mutually addressable over a network infrastructure;
c) each of said local area networks including a plurality of identifiable network elements, at least one of said network elements being subject to compromise;
d) at least one local area network including a controller for servicing or denying a service request of at least one network element;
e) at least one sensor for detecting and identifying at least one possibly compromised network element;
f) at least one directory for storing identifications of possibly compromised network elements; and
g) said network being arranged so that said at least one directory is addressable by said at least one sensor and accessible to said at least one controller whereby said at least one controller can deny a requested service to a requesting network element that is possibly compromised.

14. A wide area computer network as defined in claim 13 wherein said controller comprises a network server.

15. A wide area computer network as defined in claim 13 wherein said controller comprises a router.

16. A wide area computer network as defined in claim 13 wherein said controller comprises an authentication server.

17. A wide area computer network as defined in claim 13 wherein identifications of possibly compromised elements can be manually removed from said at least one directory.

18. A local area computer network including at least one identifiable network element subject to compromise, said local area network comprising, in combination:
a) a plurality of network elements;
b) said network elements being mutually addressable over local area network interconnections;
c) at least one controller for servicing or denying a service request of at least one network element;
d) at least one sensor for detecting and identifying at least one possibly compromised network element;
e) at least one directory for storing identifications of possibly compromised network elements; and
f) said network being arranged so that said at least one directory is addressable by said at least one sensor and accessible to said at least one controller whereby said at least one controller can deny a requested service to a requesting network element that is possibly compromised.

19. A local area computer network as defined in claim 18 wherein said controller comprises a network server.

20. A local area computer network as defined in claim 18 wherein said controller comprises a router.

21. A local area computer network as defined in claim 18 wherein said controller comprises an authentication server.

22. A local area computer network as defined in claim 18 wherein identifications of possibly compromised elements can be manually removed from said at least one directory.

23. A method for containing the spread of damage within a computer network of the type that includes at least one uniquely identifiable network element subject to compromise, said method comprising the steps of:
a) sensing a possibly compromised network element; then
b) storing the identification of said possibly compromised network element in a directory accessible to network elements that comprise choke points of said network; then
c) referring to said directory for network element identifications when a service is requested of a network element comprising a choke point of said network; and then
d) denying said requested service when the identification of said requesting network element is present in said directory.

24. A method as defined in claim 23 further including the step of providing an indication of possible compromise to a requesting network element identified as possibly compromised.

25. A method as defined in claim 24 wherein the step of sensing further includes the step of observing traffic on said network.

26. A method as defined in claim 24 wherein the step of providing an indication further includes the step of notifying a user of said compromised element.

27. A method as defined in claim 24 wherein the step of providing an indication further includes the step of halting operation of said possibly compromised network element.

28. A method as defined in claim 23 wherein said requested service comprises the assignment of a network configuration.

29. A method as defined in claim 23 wherein said requested service comprises the provision of a credential to a user of said requesting network element.
